(19) United States
(12) Patent Application Publication
(10) Pub. No.: US 2026/0051961 A1
(43) Pub. Date: Feb. 19, 2026

(54) DETERMINING AN EFFECTIVE ISOTROPIC SENSITIVITY FOR MULTIPLE TRANSMISSION AND RECEPTION POINTS

(71) Applicant: Lenovo (Singapore) Pte. Ltd., Singapore (SG)

(72) Inventor: Colin Frank, Park Ridge, IL (US)

(21) Appl. No.: 19/102,314

(22) PCT Filed: Aug. 10, 2023
(86) PCT No.: PCT/IB2023/058110

§ 371 Date: Feb. 7, 2025

Related U.S. Application Data
(60) Provisional application No. 63/371,014, filed on Aug. 10, 2022.

(51) Int. Cl. H04B 17/10; H01Q 21/00

(52) U.S. Cl. CPC H04B 17/102; H01Q 21/00

(57) ABSTRACT

Apparatuses, methods, and systems are disclosed for determining an effective isotropic sensitivity (EIS) for multiple transmission and reception points (TRPs). One method includes receiving, at a device, communications from a set of TRPs concurrently at a first panel and a second panel. The set of TRPs includes a first TRP and a second TRP. The method includes identifying a requirement for a minimum angular separation between the first TRP and the second TRP. The method includes determining a complementary cumulative distribution function for EIS based on the requirement for the minimum angular separation between the first TRP and the second TRP.

### FIELD

The subject matter disclosed herein relates generally to wireless communications and more particularly relates to determining an effective isotropic sensitivity (EIS) for multiple transmission and reception points (TRPs).

### BACKGROUND

In certain wireless communications systems, multi-panel reception may be used. In such systems, multiple transmission and reception points (TRPs) may be used.

### BRIEF SUMMARY

Methods for determining an EIS for multiple TRPs are disclosed. Apparatuses and systems also perform the functions of the methods. One embodiment of a method includes receiving, at a device, communications from a set of TRPs concurrently at a first panel and a second panel. The set of TRPs includes a first TRP and a second TRP. In some embodiments, the method includes identifying a requirement for a minimum angular separation between the first TRP and the second TRP. In certain embodiments, the method includes determining a complementary cumulative distribution function for EIS based on the requirement for the minimum angular separation between the first TRP and the second TRP.

One apparatus for determining an EIS for multiple TRPs includes a receiver to receive communications from a set of TRPs concurrently at a first panel and a second panel. The set of TRPs includes a first TRP and a second TRP. In some embodiments, the apparatus includes a processor to: identify a requirement for a minimum angular separation between the first TRP and the second TRP; and determine a complementary cumulative distribution function for EIS based on the requirement for the minimum angular separation between the first TRP and the second TRP.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 illustrates one embodiment of a wireless communications system that supports multi-antenna panel transmission and reception:

FIG. 2 illustrates one embodiment of a communication device (e.g., a user equipment (UE)) with four antenna panels that supports multi-antenna panel transmission and reception:

FIG. 3 illustrates one embodiment of a spherical coordinate system associated with testing a communication device (e.g., a UE) that supports multi-antenna panel transmission and reception:

FIG. 4 illustrates one embodiment of a signaling diagram that supports multi-antenna panel transmission and reception:

FIG. 5 illustrates one embodiment of a signaling diagram that supports multi-antenna panel transmission and reception:

FIG. 6 illustrates one embodiment of a block diagram of components of a device (e.g., a UE) that supports multi-antenna panel transmission and reception:

FIG. 7 is a schematic diagram illustrating one embodiment of a system corresponding to embodiments described herein; and

FIG. 8 is a flow chart diagram illustrating one embodiment of a method for determining an EIS for multiple TRPs.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

A wireless communications system may include one or multiple network communication devices, such as base stations, which may be otherwise known as an eNodeB (eNB), a next-generation NodeB (gNB), core network functions (CNFs), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

In 3GPP, there are two frequency ranges designated FR1 and FR2, where FR1 corresponds to the frequency range of 410 MHz-7125 MHz, and FR2 corresponds to the frequency range 24250 MHz-52600 MHz. A communication device, such as a UE, operating in FR2 (also referred to as a FR2 device) has requirements on the minimum peak effective isotropic radiated power (EIRP) that the device must achieve in at least one direction. This minimum requirement is a function of the power class and the frequency band. The other requirement that the device must achieve is a coverage requirement, which is a lower bound on the cumulative distribution function of the EIRP measured over a sphere. Specifically, the requirement is a lower bound on the EIRP that must be achieved at a specified percentile of the cumulative distribution function. The percentile that is specified depends on the power class and the corresponding device type, where the device type reflects both the form factor and the intended use of the device. Similar peak and spherical coverage requirements are defined for the effective isotropic sensitivity (EIS). However, the peak EIS is defined as an upper bound on the minimum value of the EIS in the receive beam peak direction and the coverage requirement is defined in terms of the complementary cumulative distribution function. Similar to the EIRP, the EIS requirements are a function of the power class and the frequency band.

Implementations of multi-antenna panel transmission and reception are described, such as related to reducing the testing time to evaluate a communication device (e.g., a UE) for EIRP and EIS, as well as multi-panel transmission and/or multi-panel reception with one or more TRPs, and taking into consideration a second-best transmission and/or reception beam as an aspect of coverage reliability, mitigating when the best beam of a device for transmission and/or reception may be blocked for signal transmission and/or signal reception. By utilizing the described techniques, aspects of the operability and coverage requirements for a communication device are defined.

The described techniques facilitate a reduction in testing time, particularly when evaluating a communication device (e.g., a UE) for multi-panel transmission and/or multi-panel reception with multiple TRPs, which can be time-consuming, labor intensive, complex, and expensive to perform. For example, rather than using two test probes simultaneously to measure all of the different simultaneous transmission and/or simultaneous reception pairs of directions around a device, a single testing probe can be utilized to capture the performance and measure all of the antenna panels for transmission and reception. The multi-panel transmission and/or multi-panel reception data can then be extracted from the single probe testing measurements, and evaluated post-processing for device performance of all of the antenna panels at the many combinations of azimuth and elevation as the performance of each antenna panel is measured over the entire sphere. The ability of the UE to transmit and/or receive simultaneously can then be validated by simultaneous transmission and/or simultaneous reception with a few combinations of azimuth/elevation pairs for the two TRPs which are controlled by the test equipment.

A communication device, such as a UE, operating in FR2 has requirements on the minimum peak EIRP that the device must achieve in at least one direction. This minimum requirement is a function of the power class and the frequency band. The other requirement that the device must achieve is a coverage requirement, which is a lower bound on the cumulative distribution function of the EIRP measured over a sphere. Specifically, the requirement is a lower bound on the EIRP that must be achieved at a specified percentile of the cumulative distribution function. The percentile that is specified depends on the power class and the corresponding device type, where the device type reflects both the form factor and the intended use of the device. Similar peak and spherical coverage requirements are defined for the EIS. However, the peak EIS is defined as an upper bound on the minimum value of the EIS in the receive beam peak direction and the coverage requirement is defined in terms of an upper bound on the EIS that must be achieved at a specified percentile of the complementary cumulative distribution function. Similar to the EIRP, the EIS requirements are a function of the power class and the frequency band.

A significant issue with an FR2 device (e.g., a UE) is that the signals can easily be blocked by an obstruction in front of an antenna panel of the device. Thus, even though the EIRP of the best beam in the direction of a base station (e.g., gNB) may be very good, it may often be the case that this beam is blocked by the head, hand, or body of a user of the device, or by another object. Furthermore, even if the best beam is not fully blocked, it may impinge on the user in a manner that would exceed regulatory limits for maximum permissible exposure (MPE) or specific absorption rate (SAR). As a result, the antenna panel that produces the best beam in the direction of the gNB may not be usable. For this reason, the current technique of setting the coverage requirement for a UE may not be adequate in that it does not accurately reflect the ability of the device to maintain coverage when in range of a gNB. Accordingly, aspects of the techniques described in this disclosure may be implemented to accurately reflect the ability of a device to maintain coverage and signal connection.

In addition to a device needing to maintain coverage, it is beneficial to consider the issue of multi-panel transmission and reception. Multi-panel reception can be used for a combination of increased range and/or throughput using improved receiver sensitivity, multi-input multi-output (MIMO) reception, and carrier aggregation. Similarly, multi-panel transmission can be used for a combination of increased range and/or throughput using increased transmit power, MIMO transmission, and carrier aggregation. Typically, each antenna panel in a communication device (e.g., a UE) has one set of power amplifiers for each antenna panel, where the number of power amplifiers is equal to the number of antenna elements in the antenna panel. Thus, if two panels are used to transmit simultaneously, the transmission power can be increased. Similarly, if two panels are used to receive simultaneously, the receiver sensitivity is improved because the receiver noise from the two panels is independent. In some cases, multi-panel transmission and reception may take place with the same transmission/reception point (TRP) while in other cases, the multi-panel transmission and reception may take place with multiple TRPs that are not co-located.

Aspects of the present disclosure are described in the context of a wireless communications system. Aspects of the present disclosure are further illustrated and described with reference to device diagrams and flowcharts that relate to multi-antenna panel transmission and reception.

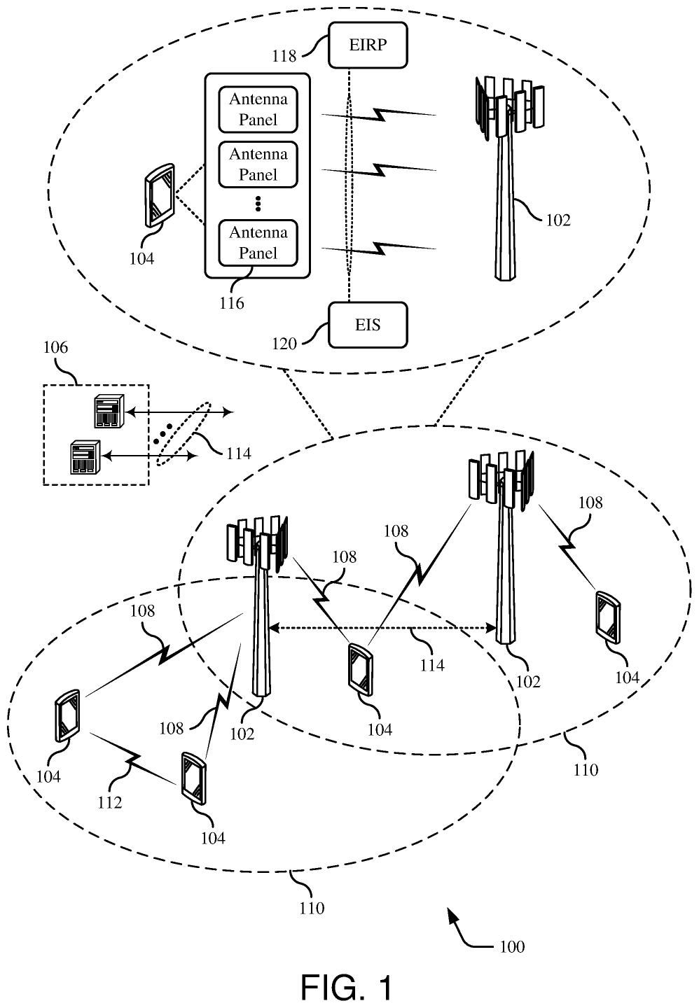

FIG. 1 illustrates one embodiment of a wireless communications system 100 that supports multi-antenna panel transmission and reception. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. For example, a base station 102 may be a transmission-reception point, referred to in this disclosure as TRP (not total radiated power). A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 118 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, a UE 104 is operable to implement various aspects of multi-antenna panel transmission and reception, as described herein. For instance, a UE 104 includes a transceiver and a set of antenna panels 116 that are each configured to transmit and/or receive signals from a TRP (e.g., a base station 102). Notably, the wireless communications system 100 can include any number of TRPs. The UE 104 can include a processor and/or communications manager (e.g., any one or more combination of components) configured to cause the UE to transmit and/or receive one or more signals with respect to one or more TRPs.

The power classes and the corresponding UE types are provided as UE power class (1) for a fixed wireless access (FWA) UE: UE power class (2) for a vehicular UE: UE power class (3) for a handheld UE: UE power class (4) for a high-power non-handheld UE; and UE power class (5) for a fixed wireless access (FWA) UE. For fixed wireless access UEs (UE power classes 1 and 5), it can be assumed that the device is installed so that an antenna panel is oriented to point in the general direction of the gNB. As a result, the gain of this antenna panel in the direction of the gNB will not be much less than the peak gain of the panel. For this reason, the gNB coverage requirement is set at 85% of the cumulative distribution function of the EIRP. For the vehicular UE (power class 2), the orientation of the antenna panels relative to the vehicle can be controlled by the car manufacturer, but the orientation of the vehicle relative to the gNB is unknown. As a result, the coverage requirement is specified at 60% of the cumulative distribution function of the EIRP. For the handheld UE (power class 3), the orientation of the device relative to the gNB is unknown and as a result the coverage requirement is set at 50% of the cumulative distribution of the EIRP. Finally, for the high-power non-handheld UE (power class 4), a high level of reliability is required, and therefore the coverage requirement is specified at 20% of the cumulative distribution function of the EIRP.

Similar peak and spherical coverage requirements are defined for the EIS. However, the peak EIS is defined as a limit on the minimum value of the EIS in the receive beam peak direction and the coverage requirement is defined in terms of the complementary cumulative distribution function. Similar to the EIRP, the EIS requirements are a function of the power class and the frequency band. For the spherical coverage requirements, the percentile values are the same as for the EIRP—that is, the percentile requirements are 85%, 60%, 50%. 20%, and 85% for the respective power classes 1, 2, 3, 4, and 5 (as described above).

The EIRP spherical coverage requirements for the different power classes are shown in the tables T1-T5 below:

TABLE T1
UE Spherical Coverage for Power Class 1

| Operating band | Min EIRP at 85%-tile CDF (dBm) |
|---|---|
| n257 | 32.0 |
| n258 | 32.0 |
| n260 | 30.0 |
| n261 | 32.0 |
| n262 | 26.0 |

NOTE 1:
Minimum EIRP at 85%-tile CDF is defined as the lower limit without tolerance
NOTE 2:
The requirements in this table are verified only under normal temperature conditions as defined in Annex E.2.1.

TABLE T2
UE Spherical Coverage for Power Class 2

| Operating band | Min EIRP at 60%-tile CDF (dBm) |
|---|---|
| n257 | 18.0 |
| n258 | 18.0 |
| n261 | 18.0 |
| n262 | 11.0 |

NOTE 1:
Minimum EIRP at 60%-tile CDF is defined as the lower limit without tolerance
NOTE 2:
The requirements in this table are verified only under normal temperature conditions as defined in Annex E.2.1.

TABLE T3
UE Spherical Coverage for Power Class 3

| Operating band | Min EIRP at 50%-tile CDF (dBm) |
|---|---|
| n257 | 11.5 |
| n258 | 11.5 |
| n259 | 5.8 |
| n260 | 8 |
| n261 | 11.5 |
| n262 | 2.9 |

NOTE 1
Minimum EIRP at 50%-tile CDF is defined as the lower limit without tolerance
NOTE 2:
Void
NOTE 3:
The requirements in this table are verified only under normal temperature conditions as defined in Annex E.2.1.

TABLE T4
UE Spherical Coverage for Power Class 4

| Operating band | Min EIRP at 20%-tile CDF (dBm) |
|---|---|
| n257 | 25 |
| n258 | 25 |
| n260 | 19 |
| n261 | 25 |
| n262 | 16.2 |

NOTE 1:
Minimum EIRP at 20%-tile CDF is defined as the lower limit without tolerance
NOTE 2:
The requirements in this table are verified only under normal temperature conditions as defined in Annex E.2.1.

TABLE T5
UE Spherical Coverage for Power Class 5

| Operating band | Min EIRP at 85%-tile CDF (dBm) |
|---|---|
| n257 | 22 |
| n258 | 22.4 |
| n259 | 19.7 |

NOTE 1:
Minimum EIRP at 85%-tile CDF is defined as the lower limit without tolerance
NOTE 2:
The requirements in this table are verified only under normal temperature conditions as defined in Annex E.2.1.

The EIS spherical coverage requirements for the different power classes are shown in the tables T6-T10 below:

TABLE T6
EIS Spherical Coverage for Power Class 1

| | EIS at 85^{th} %-tile CCDF (dBm)/Channel bandwidth | | | |
|---|---|---|---|---|
| Operating band | 50 MHz | 100 MHz | 200 MHz | 400 MHz |
| n257 | −89.5 | −86.5 | −83.5 | −80.5 |
| n258 | −89.5 | −86.5 | −83.5 | −80.5 |
| n260 | −86.5 | −83.5 | −80.5 | −77.5 |
| n261 | −89.5 | −86.5 | −83.5 | −80.5 |
| n262 | −84.3 | −81.3 | −78.3 | −75.3 |

NOTE 1:
The transmitter shall be set to PUMAX as defined in clause 6.2.4
NOTE 2:
The EIS spherical coverage requirements are verified only under normal thermal conditions as defined in Annex E.2.1.

TABLE T7
EIS Spherical Coverage for Power Class 2

| Operating | EIS at 60^{th} %-tile CCDF (dBm)/Channel bandwidth | | | |
|---|---|---|---|---|
| band | 50 MHz | 100 MHz | 200 MHz | 400 MHz |
| n257 | −81.0 | −78.0 | −75.0 | −72.0 |
| n258 | −81.0 | −78.0 | −75.0 | −72.0 |
| n261 | −81.0 | −78.0 | −75.0 | −72.0 |
| n262 | −74.9 | −71.9 | −68.9 | −65.9 |

NOTE 1:
The transmitter shall be set to PUMAX as defined in clause 6.2.4
NOTE 2:
The EIS spherical coverage requirements are verified only under normal thermal conditions as defined in Annex E.2.1.

TABLE T8
EIS Spherical Coverage for Power Class 3

| Operating | EIS at 50^{th} %-tile CCDF (dBm)/Channel bandwidth | | | |
|---|---|---|---|---|
| band | 50 MHz | 100 MHz | 200 MHz | 400 MHz |
| n257 | −77.4 | −74.4 | −71.4 | −68.4 |
| n258 | −77.4 | −74.4 | −71.4 | −68.4 |
| n259 | −71.9 | −68.9 | −65.9 | −62.9 |
| n260 | −73.1 | −70.1 | −67.1 | −64.1 |
| n261 | −77.4 | −74.4 | −71.4 | −68.4 |
| n262 | −69.7 | −66.7 | −63.7 | −60.7 |

NOTE 1:
The transmitter shall be set to PUMAX as defined in clause 6.2.4
NOTE 2:
The EIS spherical coverage requirements are verified only under normal thermal conditions as defined in Annex E.2.1.

TABLE T9
EIS Spherical Coverage for Power Class 4

| Operating | EIS at 20^{th} %-tile CCDF (dBm)/Channel bandwidth | | | |
|---|---|---|---|---|
| band | 50 MHz | 100 MHz | 200 MHz | 400 MHz |
| n257 | −88.0 | −85.0 | −82.0 | −79.0 |
| n258 | −88.0 | −85.0 | −82.0 | −79.0 |
| n260 | −83.0 | −80.0 | −77.0 | −74.0 |
| n261 | −88.0 | −85.0 | −82.0 | −79.0 |
| n262 | −78.9 | −75.9 | −72.9 | −69.9 |

NOTE 1:
The transmitter shall be set to PUMAX as defined in clause 6.2.4
NOTE 2:
The EIS spherical coverage requirements are verified only under normal thermal conditions as defined in Annex E.2.1.

TABLE T10
EIS Spherical Coverage for Power Class 5

| Operating | EIS at 85^{th} %-tile CCDF (dBm)/Channel bandwidth | | | |
|---|---|---|---|---|
| band | 50 MHz | 100 MHz | 200 MHz | 400 MHz |
| n257 | −84.6 | −81.6 | −78.6 | −75.6 |
| n258 | −84.8 | −81.8 | −78.8 | −75.8 |
| n259 | −81.7 | −78.7 | −75.7 | −72.7 |

NOTE 1:
The transmitter shall be set to PUMAX as defined in clause 6.2.4
NOTE 2:
The EIS spherical coverage requirements are verified only under normal thermal conditions as defined in Annex E.2.1.

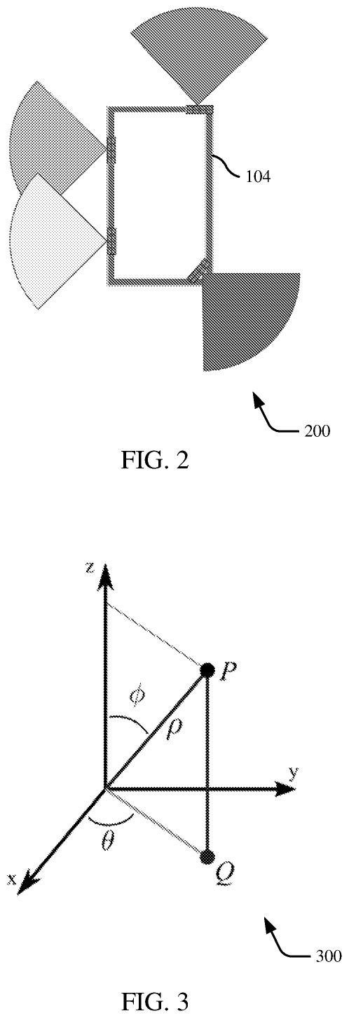

FIG. 2 illustrates one embodiment 200 of a communication device (e.g., a UE 104) with four antenna panels, as related to multi-antenna panel transmission and reception. Each antenna panel of the device is comprised of multiple antenna elements which can be dipole antennas, patch antennas, or other types of antenna elements. Each antenna element can have a single polarization or dual polarizations. The antenna elements comprising an antenna array can have uniform spacing, such as half wavelength spacing. The antenna elements can be configured as a linear array, such as in a 1×8 array with eight antenna elements in a single dimension, or as a rectangular array, such as a 2×4 array with two antenna elements in a first dimension and four antenna elements in a second dimension for a total of eight antenna elements.

For handheld devices (e.g., a UE), it can be assumed that each device will have at least two antenna panels. In order to evaluate the coverage reliability and redundancy for the device, the cumulative distribution of the second-best beam is considered for each azimuth and elevation, where the second-best beam must be from an antenna panel that is different than the antenna panel that is used to source the best beam. The cumulative distribution of the second-best beam indicates the coverage that is achievable when the best beam is either blocked or cannot be used due to MPE or SAR regulations. It should be noted that the panel used for the best beam and the panel used for the second-best beam will depend on the direction of measurement (azimuth and elevation) relative to the device.

A test and measurement mode of operation can be defined for a communication device (e.g., a UE) for measurement of the EIRP with the following designated characteristics. The UE scans for the synchronization system block (SSB) or other reference signal using each of its antenna panels. Depending on the UE capability, the UE may scan for the SSB on the antenna panels sequentially or in parallel. If the UE scans for the SSB on the antenna panels sequentially, the UE scans all of the beams on the first panel prior to scanning any of the beams on the second panel. If the UE has the capability to scan for the SSB on the antenna panels simultaneously, then the UE can scan beams for each antenna panel independently. Additionally, the UE indicates to the test equipment which antenna panels have a beam that can be used to demodulate the PBCH independently of the other panels.

Further, for each antenna panel that can demodulate the PBCH, the UE transmits a known reference signal using the best beam from that antenna panel. The reference signal is transmitted at maximum power. It can be noted that separate power amplifiers are used for each antenna panel, so that the single beam from each panel can be transmitted at full power. The test equipment measures the power of the received reference signal to determine the EIRP for the given azimuth and elevation (relative to the UE) for each antenna panel. The UE can be assigned different frequency resources (resource blocks) for each antenna panel's transmission so that the test equipment can measure the EIRP for the best beam from each antenna panel independently without the transmissions interfering with each other. If receiver blocking is a concern so that a weak signal adjacent in frequency to a strong signal may be lost due to dynamic range limitations, then the test equipment can instruct the UE to transmit on the best beams of the antenna panels sequentially using the same frequency resources.

FIG. 3 illustrates one embodiment 300 of a spherical coordinate system associated with testing a communication device (e.g., a UE 104), as related to multi-antenna panel transmission and reception. With reference to test setups, a transmit/receive test probe may be rotated in azimuth and elevation about a device that is being tested. Alternatively, the transmit/receive test probe may be fixed in position, and the device that is being tested is rotated in azimuth and elevation about the test probe. In either case, the testing integrates over the unit sphere with a radius equal to one (1).

During the EIRP test and measurement, the test equipment records the EIRP, EIRPᵢ(θⱼ,ϕⱼ) for each panel i, 1≤i≤P, where P is the number of antenna panels on the device, and for a set of azimuth and elevation angles (θⱼ,ϕⱼ), 0≤θⱼ≤2π, 0≤ϕⱼ≤π that cover the unit sphere. The measurements are taken over a set of points on a sphere centered on the device under test (e.g., the UE) with sufficient granularity to achieve the required measurement accuracy and uncertainty. The measurement points are defined with respect to their azimuth and elevation relative to the UE. The measurement points may be uniformly spaced or not, but the weight applied to each measurement when determining the cumulative distribution function or the complementary cumulative distribution function should reflect the area on the sphere that is closer to the measurement point than to any other measurement point as measured in steradians.

While taking the EIRP measurements as described above, the test equipment collects the following statistics:
1) The cumulative distribution of the best beam power received from the first antenna panel.
2) The cumulative distribution of the best beam power received from the second antenna panel.
3) The cumulative distribution of the best beam power received from the n-th antenna panel.
4) The peak power received from the first antenna panel taken over all beams and all azimuths and elevations.
5) The peak power received from the second antenna panel taken over all beams and all azimuths and elevations.
6) The peak power received from the n-th antenna panel taken over all beams and all azimuths and elevations.
7) The azimuth and elevation of the peak power of the first antenna panel.
8) The azimuth and elevation of the peak power of the second antenna panel.
9) The azimuth and elevation of the peak power of the n-th antenna panel.
10) The cumulative distribution of the power received from the best beam taken over all of the UE antenna panels.
11) The cumulative distribution of the power received from the second-best beam, where the second-best beam is the best beam taken over all of the antenna panels excluding the antenna panel of the best beam.
12) The cumulative distribution of the power received from the n-th best beam, where the n-th best beam is the best beam taken over all of the antenna panels excluding the antenna panels corresponding to the best beams up to and including the n−1-st best beam.
13) The cumulative distribution of the sum of the power received from the best beam taken over all of the antenna panels and the second-best beam, where the second-best beam is the best beam taken over all antenna panels excluding the antenna panel of the best beam and the combined power is given by:

$${EIRP}_{C} ( {θ}_{j} , {ϕ}_{j} ) = {EIRP}_{1} ( {θ}_{j} , {ϕ}_{j} ) + {EIRP}_{2} ( {θ}_{j} , {ϕ}_{j} )$$

14) The cumulative distribution of the sum of the power received on the best n beams where the j-th best beam is the best beam taken over all of the antenna panels excluding panels corresponding to the beams up to and including the j−1-st best beam and the combined power is given by:

$${EIRP}_{C} ( {θ}_{j} , {ϕ}_{j} ) = {EIRP}_{1} ( {θ}_{j} , {ϕ}_{j} ) + {EIRP}_{2} ( {θ}_{j} , {ϕ}_{j} ) + … + {EIRP}_{n} ( {θ}_{j} , {ϕ}_{j} )$$

A test and measurement mode of operation can be defined for a communication device (e.g., a UE) for determining the EIS with the following designated characteristics. The UE scans for the SSB or other reference signal using each of its antenna panels. Depending on the UE capability, the UE may scan for the SSB on the antenna panels sequentially or in parallel. If the UE scans for the SSB on the antenna panels sequentially, the UE scans all of the beams on the first panel prior to scanning any of the beams on the second panel. If the UE has the capability to scan for the SSB on the antenna panels simultaneously, then the UE can scan beams for each antenna panel independently. Additionally, the UE indicates to the test equipment which antenna panels have a beam that can be used to demodulate the PBCH independently of the other panels. The test equipment transmits a reference signal to the UE at a first power level.

Using the best beam at each antenna panel, the UE attempts to demodulate the reference signal. The beams are not combined prior to demodulation. Depending on the UE capability, the UE may demodulate the reference signal on the best beams of the UE antenna panels sequentially or in parallel. The UE determines the error rate for the demodulated test signal. Further, the UE indicates for each antenna panel whether or not the error rate exceeded the threshold defined for reference sensitivity. If the error rate was not exceeded for at least one antenna panel, the test equipment transmits the reference signal to the UE at a power level that is less than the first power level. The reference sensitivity for each antenna panel is the minimum power for which the reference signal is demodulated with an error rate less than the threshold defined for reference sensitivity.

During the EIS test and measurement, the test equipment records the EIS, EISᵢ(θⱼ,ϕⱼ) for each panel i, 1≤i≤P, where P is the number of antenna panels on the device, and for a set of azimuth and elevation angles (θⱼ,ϕⱼ), 0≤θⱼ≤2π, 0≤ϕⱼ≤π that cover the unit sphere. The measurements are taken over a set of points on a sphere centered on the device under test (e.g., the UE) with sufficient granularity to achieve the required measurement accuracy and uncertainty. The measurement points are defined with respect to their azimuth and elevation relative to the UE. The measurement points may be uniformly spaced or not, but the weight applied to each measurement when determining the cumulative distribution function or the complementary cumulative distribution function should reflect the area on the sphere that is closer to the measurement point than to any other measurement point as measured in steradians.

While taking the EIS measurements as described above, the test equipment collects the following statistics:
1) The complementary cumulative distribution of the best beam EIS for the first antenna panel.
2) The complementary cumulative distribution of the best beam EIS for the second antenna panel.
3) The complementary cumulative distribution of the best beam EIS for the n-th antenna panel.
4) The minimum EIS for the first antenna panel taken over all beams and all azimuths and elevations.
5) The minimum EIS for the second antenna panel taken over all azimuths and elevations.
6) The minimum EIS for the n-th antenna panel taken over all azimuths and elevation.
7) The azimuth and elevation of the minimum EIS of the first antenna panel.
8) The azimuth and elevation of the minimum EIS of the second antenna panel.
9) The azimuth and elevation of the minimum EIS of the n-th antenna panel.
10) The complementary cumulative distribution of best beam EIS taken over all of the antenna panels.
11) The complementary cumulative distribution of the EIS of the second-best beam where the second-best beam is the best beam taken over all of the antenna panels excluding the antenna panel of the best beam.
12) The complementary cumulative distribution of the EIS of the n-th best beam where the n-th best beam is the best beam taken over all of the antenna panels excluding the antenna panels corresponding to the best beams up to and including the n−1-st best beam.
13) The cumulative distribution of the combined EIS of the best beam taken over all of the antenna panels and the second-best beam where the second-best beam is the best beam taken over all of the antenna panels excluding the panels corresponding to the best beam, where the combined EIS is given by:

$${EIS}_{C} ( {θ}_{j} , {ϕ}_{j} ) = {( \frac{1}{{EIS}_{1} ( {θ}_{j} , {ϕ}_{j} )} + \frac{1}{{EIS}_{2} ( {θ}_{j} , {ϕ}_{j} )} )}^{- 1}$$

14) The cumulative distribution of the combined EIS of the n best beams taken over all of the antenna panels, where the j-th best beam is the best beam taken over all of the antenna panels excluding panels corresponding to the beams up to and including the j−1-st best beam, and where the combined EIS is given by:

$${EIS}_{C} ( {θ}_{j} , {ϕ}_{j} ) = {( \frac{1}{{EIS}_{1} ( {θ}_{j} , {ϕ}_{j} )} + \frac{1}{{EIS}_{2} ( {θ}_{j} , {ϕ}_{j} )} + … + \frac{1}{{EIS}_{n} ( {θ}_{j} , {ϕ}_{j} )} )}^{- 1}$$

In order to address reducing the typical measurement time required to take the EIRP and EIS measurements for a communication device (e.g., a UE) that has multiple antenna panels, innovative test modes are described in this disclosure. For the EIRP measurement, after determining the best beam for each panel for a given azimuth and elevation from the SSB, the UE transmits a reference signal with maximum power on the best beam for each antenna panel. The UE can be assigned different frequency resources (resource blocks) for each antenna panel's transmission so that the test equipment can measure the EIRP for the best beam from each antenna panel independently without the transmissions interfering with each other. For the EIS measurement, after determining the best beam for each panel for a given azimuth and elevation using the received SSB, the UE receives a reference signal from the test equipment and demodulates the reference signal independently for each antenna panel using the best beam. The UE indicates for each power level and each antenna panel whether or not the error rate exceeded the threshold defined for reference sensitivity.

When defining coverage requirements with multi-panel transmission and reception, there are primarily two cases that are taken into consideration. Notably, multi-panel requirements for a single transmission/reception point (TRP), and multi-panel requirements for two or more TRPs. In the case of the multi-panel requirements for two or more TRPs, each antenna panel transmits to and receives from a single transmission point, which is different from the TRPs from which the other antenna panels transmit and receive. Coverage requirements are considered for each of these two cases.

With respect to multi-panel, single-TRP coverage requirements, the combined EIRP, EIRP_{C}(θ,ϕ), and the combined EIS, EIS_{C}(θ,ϕ), described above in the respective steps 13 for the EIRP and EIS measurements, reflect the combined EIRP and EIS when a communication device (e.g., a UE) is using the two best panels to transmit to and receive from a single TRP. It should be noted that the two best panels will depend on the direction (θ,ϕ) of the TRP relative to the UE.

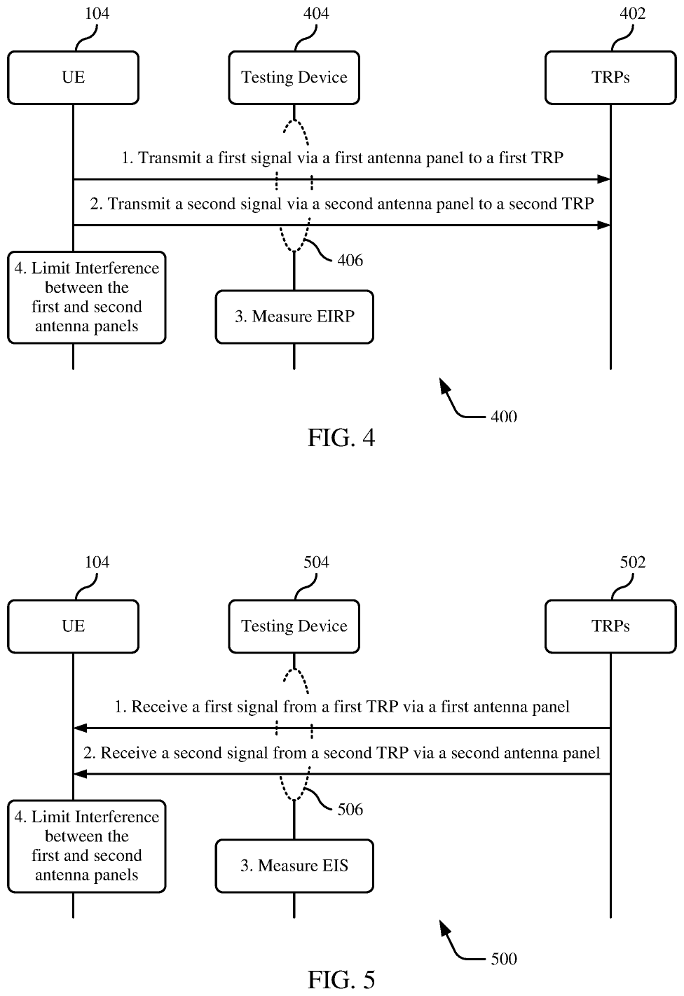

FIG. 4 illustrates one embodiment of a signaling diagram that supports multi-antenna panel transmission and reception. A communication device (e.g., a UE 104) includes at least a transceiver and a set of antenna panels. The UE 104 transmits (at step 1) a first signal from the transceiver via a first antenna panel to a first TRP 402 in a first transmission direction. The UE also transmits (at step 2) a second signal from the transceiver via a second antenna panel to a second TRP 402 in a second transmission direction. A testing device 404 receives (at 406) the first and second signals transmitted from the UE 104 to the TRPs 402, and measures (at step 3) the EIRP. The UE 104 limits interference (at step 4) between the first antenna panel and the second antenna panel. The interference by the first antenna panel is limited based on the EIRP from the first antenna panel in the second transmission direction toward the second TRP. Similarly, the interference by the second antenna panel is limited based on the EIRP from the second antenna panel in the first transmission direction toward the first TRP. Although the UE 104 and the testing device 402 are illustrated and described as separate devices and/or components, the testing device or comparable logic may be integrated with the UE.

FIG. 5 illustrates one embodiment of a signaling diagram that supports multi-antenna panel transmission and reception. A communication device (e.g., a UE 104) includes at least a transceiver and a set of antenna panels. The UE 104 receives (at step 1) a first signal from a first TRP 502 in a first reception direction via a first antenna panel. The UE also receives (at step 2) a second signal from a second TRP 502 in a second reception direction via a second antenna panel. A testing device 504 controls (at 506) the first and second signals transmitted from the TRPs 502 to the UE 104, and based on the EIRP of the TRPs in the direction of the UE, determines (at step 3) the EIS. The UE 104 limits interference (at step 4) between the first antenna panel and the second antenna panel. The interference by the first antenna panel is limited based on the EIS of the first antenna panel in the second reception direction of the second TRP. Similarly, the interference by the second antenna panel is limited based on the EIS of the second antenna panel in the first reception direction of the first TRP. Although the UE 104 and the testing device 502 are illustrated and described as separate devices and/or components, the testing device or comparable logic may be integrated with the UE.

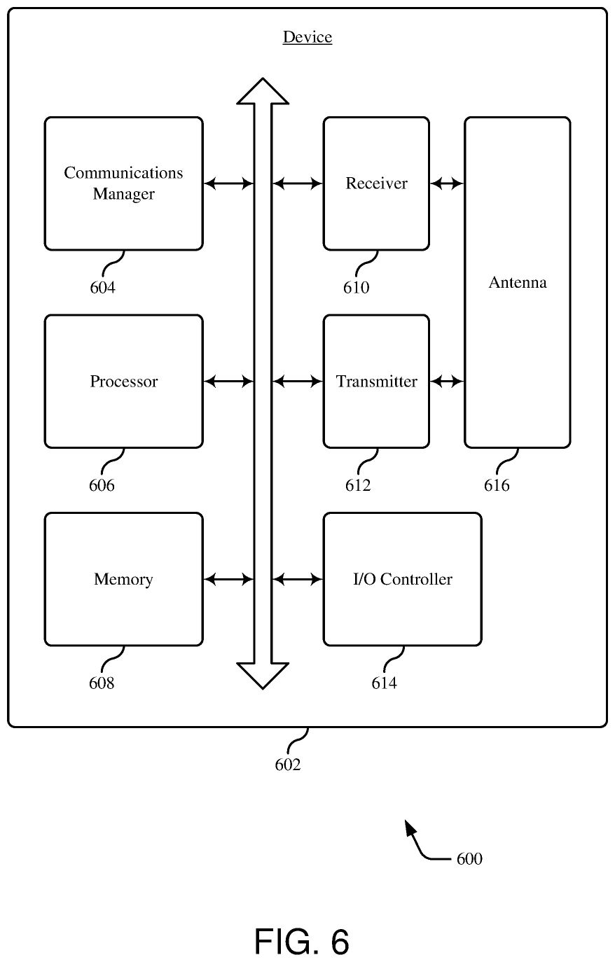

FIG. 6 illustrates one embodiment of a block diagram 600 of a device 602 that supports multi-antenna panel transmission and reception. The device 602 may be an example of a UE 104 as described herein. The device 602 may support wireless communication and/or network signaling with one or more base stations 102, other UEs 104, network entities and devices, or any combination thereof. The device 602 may include components for bi-directional communications including components for transmitting and receiving communications, such as a communications manager 604, a processor 606, a memory 608, a receiver 610, a transmitter 612, and an I/O controller 614. These components may be in electronic communication or otherwise coupled (e.g., operatively, communicatively, functionally, electronically, electrically) via one or more interfaces (e.g., buses).

The communications manager 604, the receiver 610, the transmitter 612, or various combinations thereof or various components thereof may be examples of means for performing various aspects of the present disclosure as described herein. For example, the communications manager 604, the receiver 610, the transmitter 612, or various combinations or components thereof may support a method for performing one or more of the functions described herein.

In some implementations, the communications manager 604, the receiver 610, the transmitter 612, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 606 and the memory 608 coupled with the processor 606 may be configured to perform one or more of the functions described herein (e.g., by executing, by the processor 606, instructions stored in the memory 608).

Additionally, or alternatively, in some implementations, the communications manager 604, the receiver 610, the transmitter 612, or various combinations or components thereof may be implemented in code (e.g., as communications management software or firmware) executed by the processor 606. If implemented in code executed by the processor 606, the functions of the communications manager 604, the receiver 610, the transmitter 612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 604 may be configured to perform various operations (e.g., receiving, monitoring, transmitting) using or otherwise in cooperation with the receiver 610, the transmitter 612, or both. For example, the communications manager 604 may receive information from the receiver 610, send information to the transmitter 612, or be integrated in combination with the receiver 610, the transmitter 612, or both to receive information, transmit information, or perform various other operations as described herein. Although the communications manager 604 is illustrated as a separate component, in some implementations, one or more functions described with reference to the communications manager 604 may be supported by or performed by the processor 606, the memory 608, or any combination thereof. For example, the memory 608 may store code, which may include instructions executable by the processor 606 to cause the device 602 to perform various aspects of the present disclosure as described herein, or the processor 606 and the memory 608 may be otherwise configured to perform or support such operations.

For example, the communications manager 604 may support wireless communication and/or network signaling at a device (e.g., the device 602, a UE) in accordance with examples as disclosed herein. The communications manager 604 and/or other device components may be configured as or otherwise support an apparatus, such as a UE.

The communications manager 604 and/or other device components may be configured as or otherwise support a means for wireless communication and/or network signaling at a UE.

The processor 606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 606 may be configured to operate a memory array using a memory controller. In some other implementations, a memory controller may be integrated into the processor 606. The processor 606 may be configured to execute computer-readable instructions stored in a memory (e.g., the memory 608) to cause the device 602 to perform various functions of the present disclosure.

The memory 608 may include random access memory (RAM) and read-only memory (ROM). The memory 608 may store computer-readable, computer-executable code including instructions that, when executed by the processor 606 cause the device 602 to perform various functions described herein. The code may be stored in a non-transitory computer-readable medium such as system memory or another type of memory. In some implementations, the code may not be directly executable by the processor 606 but may cause a computer (e.g., when compiled and executed) to perform functions described herein. In some implementations, the memory 608 may include, among other things, a basic I/O system (BIOS) which may control basic hardware or software operation such as the interaction with peripheral components or devices.

The I/O controller 614 may manage input and output signals for the device 602. The I/O controller 614 may also manage peripherals not integrated into the device 602. In some implementations, the I/O controller 614 may represent a physical connection or port to an external peripheral. In some implementations, the I/O controller 614 may utilize an operating system such as iOS®, ANDROID®, MS-DOS®, MS-WINDOWS®, OS/2®, UNIX®, LINUX®, or another known operating system. In some implementations, the I/O controller 614 may be implemented as part of a processor, such as the processor 606. In some implementations, a user may interact with the device 602 via the I/O controller 614 or via hardware components controlled by the I/O controller 614.

In some implementations, the device 602 may include a single antenna 616. However, in some other implementations, the device 602 may have more than one antenna 616, which may be capable of concurrently transmitting or receiving multiple wireless transmissions. The receiver 610 and the transmitter 612 may communicate bi-directionally, via the one or more antennas 616, wired, or wireless links as described herein. For example, the receiver 610 and the transmitter 612 may represent a wireless transceiver and may communicate bi-directionally with another wireless transceiver. The transceiver may also include a modem to modulate the packets, to provide the modulated packets to one or more antennas 616 for transmission, and to demodulate packets received from the one or more antennas 616.

It should be noted that one or more embodiments described herein may be combined into a single embodiment.

In certain embodiments, such as for NR frequency range 2 (FR2) multi-RX chain, DL reception may have the following objectives: 1) have requirements for enhanced FR2 UEs with simultaneous DL reception with two different QCL TypeD RSs on single component carrier with up to 4 layer DL MIMO: 2) have enhanced RF requirements: specify RF requirements, mainly spherical coverage requirements, for devices with simultaneous reception from different directions with different QCL TypeD RSs.

In some embodiments, it may be determined how to define spherical coverage requirements with simultaneous reception from different directions. Additionally, given the difficulty of placing two probes at all pairs of directions relative to the UE as well as the time required to take measurements over a sufficiently large number of direction pairs to accurately determine coverage, it may be possible to estimate multi-Rx spherical coverage using a single measurement probe. Multiple probes may then be used to verify the ability of the UE to receive simultaneously over a small number of direction pairs within the coverage region.

In various embodiments, a single direction spherical coverage is defined in terms of the complementary distribution function of the effective isotropic sensitivity (EIS). Let EIS_{i,j}(ϕ,θ) denote the EIS (in dB) of the j-th beam of the i-th antenna panel in the direction (ϕ,θ) where the number of antenna panels is P and the number of beams per panel is B. Let EIS; (ϕ,θ) denote the EIS of the best beam from the i-th antenna panel so that:

$${EIS}_{i} ( ϕ , θ ) = {min}_{1 \leq j \leq B} {EIS}_{i , j} ( ϕ , θ ) .$$

For a given EIS value a, let A(a) denote the set of directions (ϕ,θ) such that:

$$A ( a ) = \{ ( ϕ , θ ) : {min}_{1 \leq i \leq P} {EIS}_{i} ( ϕ , θ ) \leq a \} .$$

With this definition, the complementary cumulative distribution function of the EIS for single panel reception can be expressed as:

$${CCDF}_{1 Rx} ( a ) = 1 - \frac{1}{4 π} {{\int }_{ϕ = 0}}^{2 π} {{\int }_{θ = 0}}^{π} {I}_{A ( a )} ( ϕ , θ ) sin θ d θ d ϕ$$

where I_{A(a)}(ϕ,θ) is the indicator function given by:

$${I}_{A ( a )} ( ϕ , θ ) = \{ \begin{matrix}1 & ( ϕ , θ ) ∈ A ( a ) \\ 0 & else\end{matrix} .$$

For simultaneous reception of independently modulated signals from different directions, let:

$${EIS}^{1} ( ( {ϕ}_{1} , {θ}_{1} ) , ( {ϕ}_{2} , {θ}_{2} ) )$$

$${EIS}^{2} ( ( {ϕ}_{1} , {θ}_{1} ) , ( {ϕ}_{2} , {θ}_{2} ) )$$

denote the EIS measured for directions (ϕ₁,θ₁) and (ϕ₂,θ₂), respectively, when equal power is transmitted from these directions. Let Aₛᵢₘᵤₗₜ(a) denote the set for which both EIS¹((ϕ₁,θ₁), (ϕ₂,θ₂)) and EIS²((ϕ₁,θ₁), (ϕ₂,θ₂)) are both less than or equal to a so that:

$${A}_{simult} ( a ) = \{ \begin{matrix}( {ϕ}_{1} , {θ}_{1} ) , ( {ϕ}_{2} , {θ}_{2} ) : {EIS}^{1} ( ( {ϕ}_{1} , {θ}_{1} ) , ( {ϕ}_{2} , {θ}_{2} ) ) \leq a \\ and {EIS}^{2} ( ( {ϕ}_{1} , {θ}_{1} ) , ( {ϕ}_{2} , {θ}_{2} ) ) \leq a\end{matrix} \} .$$

With this definition, the complementary cumulative distribution function for simultaneous reception of signals from two directions can be expressed as:

$${CCDF}_{s i m u l t} ( a ) = 1 - \frac{1}{16 {π}^{2}} {\int }_{{ϕ}_{1} = 0}^{2 π} {\int }_{{θ}_{1} = 0}^{π} {\int }_{{ϕ}_{2} = 0}^{2 π} {\int }_{{θ}_{2} = 0}^{π} {I}_{{A}_{s i m u l t} ( a )} ( {ϕ}_{1} , {θ}_{1} , {ϕ}_{2} , {θ}_{2} ) sin {θ}_{2} sin {θ}_{1} d {θ}_{2} d {ϕ}_{2} d {θ}_{1} d {ϕ}_{1}$$

where I_{A}_{ₛᵢₘᵤₗₜ}₍ₐ₎(ϕ₁,θ₁, ϕ₂,θ₂) is the indicator function given by:

$${I}_{{A}_{s i m u l t} ( a )} ( {ϕ}_{1} , {θ}_{1} , {ϕ}_{2} , {θ}_{2} ) = \{ \begin{matrix}1 & ( {ϕ}_{1} , {θ}_{1} ) , ( {ϕ}_{2} , {θ}_{2} ) ∈ {A}_{simult} ( a ) \\ 0 & else\end{matrix} .$$

It should be noted that the complementary cumulative distribution function for simultaneous reception of independently modulated signals from two directions can be expressed as:

$${CCDF}_{s i m u l t} ( a ) = 1 - \frac{1}{16 {π}^{2}} {\int }_{{ϕ}_{1} = 0}^{2 π} {\int }_{{θ}_{1} = 0}^{π} {\int }_{{ϕ}_{2} = 0}^{2 π} {\int }_{{θ}_{2} = 0}^{π} {I}_{{A}_{s i m u l t} ( a )} ( {ϕ}_{1} , {θ}_{1} , {ϕ}_{2} , {θ}_{2} ) sin {θ}_{2} sin {θ}_{1} d {θ}_{2} d {ϕ}_{2} d {θ}_{1} d {ϕ}_{1} .$$

Given the difficulty of placing two probes at all possible pairs of directions relative to the UE as well as the time required to take measurements over a sufficiently large number of direction pairs to accurately determine coverage, we consider whether it is possible to estimate multi-Rx spherical coverage for simultaneous reception from two directions using a single measurement probe.

For simultaneous reception from two different directions, it may be initially considered a case in which there are at least two Rx chains per panel. Independently modulated signals are considered from a pair of directions (ϕ₁,θ₁) and (ϕ₂,θ₂). To determine the EIS for each signal when these signals are received simultaneously, the interference between them is considered. If the first signal is received on the j-th beam of the i-th panel, let t denote the interference from the second signal which is given by:

$$E I {S}_{i , j} ( {ϕ}_{2} , {θ}_{2} ) - {EIS}_{i , j} ( {ϕ}_{1} , {θ}_{1} ) = t .$$

If the signal-to-noise ratio required to meet reference sensitivity is given by SNR_{ref}, and if the EIS without interference is given by a so that:

$$E I {S}_{i , j} ( {ϕ}_{1} , {θ}_{1} ) = a ,$$

then it can be shown that the EIS with interference from the second direction is given by a−f(t) (note that f(t) is negative), where:

$$f ( t ) = 10 {log}_{10} ( 1 - 1 {0}^{( S N {R}_{r e f} - t ) / 10} ) .$$

Thus, for the EIS with interference to be equal to a, the EIS without interference must be equal to a+f(t). It can be noted that to achieve reference sensitivity, it must be that:

$$t > {SNR}_{r e f} .$$

Furthermore, the maximum achievable SNR is also equal to t, so it may be important to choose t large enough to enable the use of higher order modulations.

Moreover, it follows that signals from directions (ϕ₁,θ₁) and (ϕ₂,θ₂) can be received simultaneously, each with Refsens≤a (including interference between the signals), if there exist indices i, j, k, and l and threshold t>SNR_{ref} which satisfy the following four conditions:

$$1 ) \qquad EI {S}_{i , j} ( {ϕ}_{1} , {θ}_{1} ) \leq a + f ( t ) for 1 \leq i \leq P , and 1 \leq j \leq B$$

$$2 ) \qquad EI {S}_{k , l} ( {ϕ}_{2} , {θ}_{2} ) \leq a + f ( t ) for k \neq i or l \neq j where 1 \leq k \leq P and 1 \leq l \leq B$$

$$3 ) \qquad EI {S}_{i , j} ( {ϕ}_{2} , {θ}_{2} ) - E I {S}_{i , j} ( {ϕ}_{1} , {θ}_{1} ) \geq t$$

$$4 ) \qquad EI {S}_{k , l} ( {ϕ}_{1} , {θ}_{1} ) - E I {S}_{k , l} ( {ϕ}_{2} , {θ}_{2} ) \geq t$$

It can be noted that for conditions 3) and 4) it is assumed that the powers transmitted from the directions (ϕ₁,θ₁) and (ϕ₂,θ₂) are equal.

Let the set C_{2Rx/pan}(a,t) denote the set of direction pairs (ϕ₁,θ₁) and (ϕ₂,θ₂) meeting these four conditions so that:

$${C}_{2 Rx / pan} ( a , t ) = \{ \begin{matrix}( {ϕ}_{1} , {θ}_{1} , {ϕ}_{2} , {θ}_{2} ) such that there exist indices i , j , k , l and threshold t > S N {R}_{ref} \\ for which conditions 1 - 4 are met\end{matrix} \} .$$

The cumulative distribution function for simultaneous reception from two different directions can then be expressed as:

$${CDF}_{2 Rx / pan} ( a , t ) = \frac{1}{16 {π}^{2}} {\int }_{{ϕ}_{1} = 0}^{2 π} {\int }_{{θ}_{1} = 0}^{π} {\int }_{{ϕ}_{2} = 0}^{2 π} {\int }_{{θ}_{2} = 0}^{π} {I}_{{C}_{2 Rx / pan} ( a , t )} ( {ϕ}_{1} , {θ}_{1} , {ϕ}_{2} , {θ}_{2} ) sin {θ}_{2} sin {θ}_{1} d {θ}_{2} d {ϕ}_{2} d {θ}_{1} d {ϕ}_{1}$$

$$where$$

$${I}_{{C}_{2 Rx / pan ( a , t )}} ( {ϕ}_{1} , {θ}_{1} , {ϕ}_{2} , {θ}_{2} ) is the indicator function given by : {I}_{{C}_{2 Rx / pan} ( a , t )} ( {ϕ}_{1} , {θ}_{1 ,} , {ϕ}_{2} , {θ}_{2} ) = \{ \begin{matrix}1 & ( {ϕ}_{1} , {θ}_{1} , {ϕ}_{2} , {θ}_{2} ) ∈ {C}_{2 Rx / pan} ( a , t ) \\ 0 & else\end{matrix} .$$

The complementary cumulative distribution function can then be defined as:

$${CCDF}_{2 Rx / pan} ( a , t ) = 1 - {CDF}_{2 Rx / pan} ( a , t ) .$$

To enable this method for estimating the distribution function of EIS with simultaneous reception, the UE must report the indices of the panel and the beam that are used for reception of the test signal. To enable the test equipment to correctly apply this definition using single probe measurements, the UE must indicate that it has multiple Rx chains per panel. If only some panels have multiple Rx chains, then the UE must indicate which panels have multiple Rx chains and which do not. Additionally, it may be beneficial for the UE to indicate the threshold t to that the UE applies, or which the test equipment should apply, when determining the condition for simultaneous reception.

In various embodiments, to compute CCDF_{2Rx/pan}(a,t), it is necessary for the measurement equipment to measure EIS_{i,j}(ϕ,θ) for panel i and beam j over a range of ϕ and θ that is larger than the range for which this beam is the best beam. To determine the region C_{2Rx/pan}(a,t) in which the threshold t is met between the two beams so that:

$$E I {S}_{i , j} ( {ϕ}_{2} , {θ}_{2} ) - {EIS}_{i , j} ( {ϕ}_{1} , {θ}_{1} ) \geq t .$$

the best beam measurement for j-th beam of the i-th panel must also be taken over the region (ϕ,θ) for which it is not the best beam but for which EIS_{i,j}(ϕ,θ) is less than t+EISₘₐₓ where EISₘₐₓ is the largest EIS value of interest. For this reason, it may be beneficial for the UE to support a test mode of operation in which it reports EIS for any beam for which EIS is less than t+EISₘₐₓ.

For a single Rx chain per panel, the definition is the same as for multiple Rx chains with the exception that the two beams cannot be received by the same panel. Independently modulated signals are considered from a pair of directions (ϕ₁,θ₁) and (ϕ₂,θ₂). Signals from directions (ϕ₁,θ₁) and (ϕ₂,θ₂) can be received simultaneously, each with Refsens≤a (including interference between the signals), if there exist indices i, j, k, and l and threshold t>SNR_{ref} which satisfy the following four conditions:

$$1 ) \qquad EI {S}_{i , j} ( {ϕ}_{1} , {θ}_{1} ) \leq a + f ( t ) for 1 \leq i \leq P , and 1 \leq j \leq B$$

$$2 a ) \qquad EI {S}_{k , l} ( {ϕ}_{2} , {θ}_{2} ) \leq a + f ( t ) for k \neq i where 1 \leq k \leq P and 1 \leq l \leq B$$

$$3 ) \qquad EI {S}_{i , j} ( {ϕ}_{2} , {θ}_{2} ) - E I {S}_{i , j} ( {ϕ}_{1} , {θ}_{1} ) \geq t$$

$$4 ) \qquad EI {S}_{k , l} ( {ϕ}_{1} , {θ}_{1} ) - E I {S}_{k , l} ( {ϕ}_{2} , {θ}_{2} ) \geq t$$

where the only difference between condition 2) above and condition 2a) here is that k≠i since the same panel cannot be used for the second beam when each panel has only a single Rx chain.

If the set C_{1Rx/pan}(a,t) is defined as the set of direction pairs (ϕ₁,θ₁) and (ϕ₂,θ₂) meeting these conditions so that:

$${C}_{1 Rx / pan} ( a , t ) = \{ \begin{matrix}( {ϕ}_{1} , {θ}_{1} , {ϕ}_{2} , {θ}_{2} ) such that there exist indices i , j , k , l and threshold t > S N {R}_{ref} \\ for which conditions 1 , 2 a , 3 , and 4 are met\end{matrix} \}$$

then the cumulative distribution function for simultaneous reception from two different directions can be expressed as:

$${CDF}_{1 Rx / pan} ( a , t ) = \frac{1}{16 {π}^{2}} {\int }_{{ϕ}_{1} = 0}^{2 π} {\int }_{{θ}_{1} = 0}^{π} {\int }_{{ϕ}_{2} = 0}^{2 π} {\int }_{{θ}_{2} = 0}^{π} {I}_{{C}_{1 Rx / pan} ( a , t )} ( {ϕ}_{1} , {θ}_{1} , {ϕ}_{2} , {θ}_{2} ) sin {θ}_{2} sin {θ}_{1} d {θ}_{2} d {ϕ}_{2} d {θ}_{1} d {ϕ}_{1}$$

where I_{C}_{_{1Rx/pan(a,t)}}(ϕ₁,θ₁, ϕ₂,θ₂) is the indicator function given by:

$${I}_{{C}_{1 Rx / pan} ( a , t )} ( {ϕ}_{1} , {θ}_{1} , {ϕ}_{2} , {θ}_{2} ) = \{ \begin{matrix}1 & ( {ϕ}_{1} , {θ}_{1} , {ϕ}_{2} , {θ}_{2} ) ∈ {C}_{1 Rx / pan} ( a , t ) \\ 0 & else\end{matrix} .$$

The complementary cumulative distribution function is then defined as:

$${CCDF}_{1 Rx / pan} ( a , t ) = 1 - {CDF}_{1 Rx / pan} ( a , t ) .$$

To enable this method for estimating the distribution function of EIS with simultaneous reception, the UE must report the indices of the panel and the beam that are used for reception of the test signal. In addition, to enable the test equipment to correctly apply this definition, the UE must indicate that it has only a single Rx chain per panel. If some panels have multiple Rx chains, then the UE must indicate which panels have multiple Rx chains and which do not.

If the antenna panels have non-overlapping coverage so that a signal from direction (ϕ,θ) can only be received on at most one panel, then the cumulative distribution function of the EIS when receiving from two directions simultaneously can be determined from the cumulative distribution function of the EIS for each panel when receiving from a single direction.

For a device with two antenna panels with non-overlapping coverage, let CDF_{1,1Rx/pan}(a) and CDF_{2,1Rx/pan}(a) denote the cumulative distribution function of the EIS for the first and second antenna panes respectively. In this case, the cumulative distribution function of the EIS when receiving from two directions simultaneously is given by:

$${CDF}_{1 Rx / pan} ( a , t ) = {CDF}_{1 Rx / pan} ( a ) = 2 * {CDF}_{1 , 1 Rx / pan} ( a ) * {CDF}_{2 , 1 Rx / pan} ( a ) .$$

For the case of a single Rx chain per panel, it is generally not possible for the UE to receive from two TRP's which are closely adjacent in angle with respect to the UE. For this reason, it seems reasonable to consider the complementary cumulative distribution of the multi-panel multi-TRP coverage conditioned on a minimum angular separation of the two TRP's.

For two TRP's in directions (ϕ₁,θ₁) and (ϕ₂,θ₂), rays originating from the UE in in the direction of these two TRP's intersect the unit sphere with coordinates:

$$( {x}_{1} , {y}_{1} , {z}_{1} ) = ( sin {θ}_{1} cos {ϕ}_{1} , sin {θ}_{1} sin {ϕ}_{1} , cos {θ}_{1} )$$

$$( {x}_{2} , {y}_{2} , {z}_{2} ) = ( sin {θ}_{2} cos {ϕ}_{2} , sin {θ}_{2} sin {ϕ}_{2} , cos {θ}_{2} )$$

The angle ψ between these two rays can be computed as the inverse cosine of the inner product, so that:

$$\begin{matrix}ψ = {cos}^{- 1} ( sin {θ}_{1} cos {ϕ}_{1} sin {θ}_{2} cos {ϕ}_{2} + sin {θ}_{1} sin {ϕ}_{1} sin {θ}_{2} sin {ϕ}_{2} + cos {θ}_{1} cos {θ}_{2} ) \\ = {cos}^{- 1} ( sin {θ}_{1} sin {θ}_{2} cos ( {ϕ}_{1} - {ϕ}_{2} ) + cos {θ}_{1} cos {θ}_{2} )\end{matrix}$$

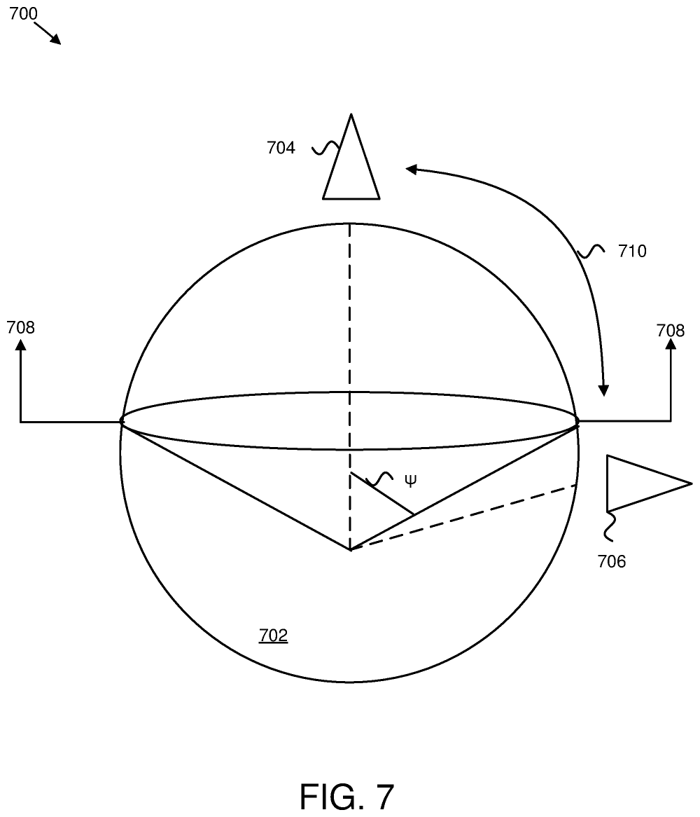

As indicated in FIG. 7, let E(ψ,(ϕ₁,θ₁)) denote the exclusion zone of angle ψ around the direction (ϕ₁,θ₁). The area of this exclusion zone on the unit sphere (measured in steradians) is given by:

$$2 π ( 1 - cos ψ ) ,$$

for which the corresponding fraction of the sphere which is excluded is given by:

$$\frac{2 π ( 1 - cos ψ )}{4 π} = \frac{1 - cos ψ}{2} .$$

Let Ē(ψ,(ϕ,θ)) denote the complement of the exclusion zone, and note that the fraction of the sphere which is not excluded is given by:

$$\frac{4 π - 2 π ( 1 - cos ψ )}{4 π} = \frac{1 + cos ψ}{2}$$

In the case of a single Rx chain per panel, signals from directions (ϕ₁,θ₁) and (ϕ₂,θ₂) can be received simultaneously, each with Refsens≤a (including interference between the signals), if there exist indices i, j, k, and l and threshold t>SNR_{ref} such that conditions 1, 2a, 3, and 4 are met. As before, the set is defined as:

$${C}_{1 Rx / pan} ( a , t ) = \{ \begin{matrix}( {ϕ}_{1} , {θ}_{1} , {ϕ}_{2} , {θ}_{2} ) such that there exist indices i , j , k , l and threshold \\ t > {SNR}_{ref} for which conditions 1 , 2 a , 3 , and 4 are met\end{matrix} \} .$$

With the above definitions, the conditional cumulative distribution function of simultaneous reception from two different directions can be expressed as:

$${CDF}_{1 Rx / pan} ( a , t , ψ ) = \frac{1}{8 {π}^{2} ( 1 + cos ψ )} {\int }_{{ϕ}_{1} = 0}^{2 π} {\int }_{{θ}_{1} = 0}^{π} {\int \int }_{( {ϕ}_{2} , {θ}_{2} ) ϵ \overline{E} ( ψ , ( {ϕ}_{1} , {θ}_{1} ) )} {I}_{1 RxP ( a , t )} ( {ϕ}_{1} , {θ}_{1} , {ϕ}_{2} , {θ}_{2} ) sin {θ}_{2} sin {θ}_{1} d {θ}_{2} d {ϕ}_{2} d {θ}_{1} d {ϕ}_{1}$$

The conditional complementary cumulative distribution function can then be defined as:

$$\begin{matrix}{CCDF}_{1 Rx / pan} ( a , t , ψ ) = 1 - {CDF}_{1 Rx / pan} ( a , t , ψ ) \\ = 1 - \frac{1}{8 {π}^{2} ( 1 + cos ψ )} {\int }_{{ϕ}_{1} = 0}^{2 π} {\int }_{{θ}_{1} = 0}^{π} {\int \int }_{( {ϕ}_{2} , {θ}_{2} ) ϵ \overline{E} ( ψ , ( {ϕ}_{1} , {θ}_{1} ) )} \\ {I}_{{C}_{1 Rx / pan} ( a , t )} ( {ϕ}_{1} , {θ}_{1} , {ϕ}_{2} , {θ}_{2} ) sin {θ}_{2} sin {θ}_{1} d {θ}_{2} d {ϕ}_{2} d {θ}_{1} d {ϕ}_{1}\end{matrix}$$

It can be noted that this conditional complementary cumulative distribution function is a function of both the size of the exclusion zone (determined by ψ) and the threshold t. As the angle ψ is increased, the size of the exclusion zone is increased. In some cases, it may be beneficial for the UE to signal a minimum angular separation ψₘᵢₙ which indicates the minimum angular separation between TRP's for which simultaneous reception by the UE is possible.

FIG. 7 is a schematic diagram illustrating one embodiment of a system 700 corresponding to embodiments described herein. FIG. 7 illustrates a region E(ψ,(ϕ₁,θ₁)) from which the second TRP is excluded when determining conditional spherical coverage for a minimum separation angle ψ. The system 700 includes a UE showing a sphere 7θ₂ reception area around the UE. Moreover, the system includes a TRP 1 (ϕ₁,θ₁) 704 and a TRP 2 (ϕ₂,θ₂) 706. A portion 708 of the sphere 702 is an exclusion zone, and a distance 710 where Ω≥ψ is between the TRP 1 704 and the TRP 2 706. Moreover, E(ψ,(ϕ,θ)) denotes the exclusion zone of angle ψ around the direction (ϕ,θ). The area of this exclusion zone on the unit sphere (measured in steradians) is given by:

$$2 π ( 1 - cos ψ ) ,$$

for which the corresponding fraction of the sphere 702 that is excluded is given by:

$$\frac{2 π ( 1 - cos ψ )}{4 π} = \frac{1 - cos ψ}{2} .$$

Let Ē(ψ,(ϕ,θ)) denote the complement of the exclusion zone, and note that the fraction of the sphere 702 which is not excluded is given by:

$$\frac{4 π - 2 π ( 1 - cos ψ )}{4 π} = \frac{1 + cos ψ}{2}$$

In certain embodiments, an EIS spherical coverage requirement may be defined when receiving from multiple directions simultaneously. Given the extreme difficulty of measuring the cumulative distribution of the EIS when receiving from multiple directions simultaneously, there may be methods for estimating the cumulative distribution function based on measurements taken using a single probe. Based on embodiments found herein, the following may be used:
1) use single probe measurements to estimate spherical coverage for multi-Rx reception from multiple directions simultaneously using single probe measurements;
2) To enable the test equipment to estimate the distribution function of the EIS with simultaneous reception from single probe measurements, the UE must report the indices of the panel and the beam that are used for reception of the test signal
3) the UE may indicate the threshold t which is used by the UE, or which should be used by the test equipment when estimating coverage, when determining whether or not simultaneous reception is used by the UE
4) the UE may support a test mode of operation in which it reports EIS for any beam for which EIS is less than t+EISₘₐₓ.
5) verify simultaneous reception using multiple probes for a set of points within the estimated coverage region;
6) adopt the definition for the cumulative distribution function of the EIS when receiving from multiple directions simultaneously given by:

$${CCDF}_{simult} ( a ) = 1 - \frac{1}{16 {π}^{2}} {\int }_{{ϕ}_{1} = 0}^{2 π} {\int }_{{θ}_{1} = 0}^{π} {\int }_{{ϕ}_{2} = 0}^{2 π} {\int }_{{θ}_{2} = 0}^{π} {I}_{{A}_{simult} ( a )} ( {ϕ}_{1} , {θ}_{1} , {ϕ}_{2} , {θ}_{2} ) sin {θ}_{2} sin {θ}_{1} d {θ}_{2} d {ϕ}_{2} d {θ}_{1} d {ϕ}_{1} ;$$

7) the UE should indicate which panels have multiple Rx chains and the capability to receive from multiple directions simultaneously; and
8) in the case of a single RX chain per panel, define the cumulative distribution function for receiving from two directions simultaneously conditioned on a minimum angular separation of the two directions.
9) in the case of a single Rx chain per panel, it may be beneficial for the UE to signal a minimum angular separation Ømin which indicates the minimum angular separation between TRP's for which simultaneous reception by the UE is possible.

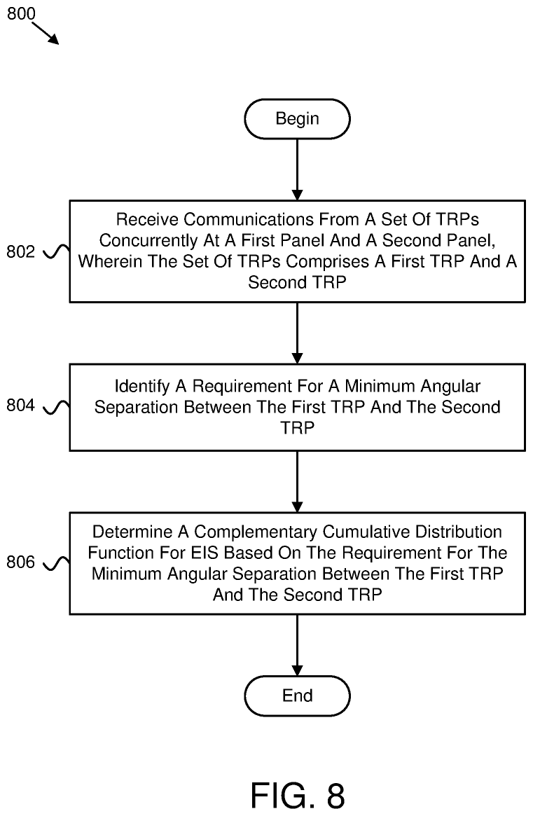

FIG. 8 is a flow chart diagram illustrating one embodiment of a method 800 for determining an EIS for multiple TRPs. In some embodiments, the method 800 is performed by an apparatus, such as the remote unit 102. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes receiving 802, at a device, communications from a set of TRPs concurrently at a first panel and a second panel. The set of TRPs includes a first TRP and a second TRP. In some embodiments, the method 800 includes identifying 804 a requirement for a minimum angular separation between the first TRP and the second TRP. In certain embodiments, the method 800 includes determining 806 a complementary cumulative distribution function for EIS based on the requirement for the minimum angular separation between the first TRP and the second TRP.

In certain embodiments, the complementary cumulative distribution function is a conditional complementary cumulative distribution function. In some embodiments, the conditional complementary cumulative distribution function is used to set an EIS requirement, and the EIS requirement is less than a threshold value. In various embodiments, the conditional complementary cumulative distribution function comprises a maximum interference requirement for the set of TRPs.

In one embodiment, the complementary cumulative distribution function is based on an exclusion zone. In certain embodiments, the exclusion zone is determined by an exclusion angle. In some embodiments, a size of the exclusion zone increases as the exclusion angle increases.

In various embodiments, the exclusion zone indicates a set of directions for which an angle between any direction in the set of directions and a direction of a first TRP is less than an exclusion angle and from which the second TRP is excluded. In one embodiment, the EIS is expressed in dB. In certain embodiments, the EIS is determined for a best beam of the first panel and for a best beam of the second panel.

In one embodiment, an apparatus comprises: a receiver to receive communications from a set of TRPs concurrently at a first panel and a second panel, wherein the set of TRPs comprises a first TRP and a second TRP; and a processor to: identify a requirement for a minimum angular separation between the first TRP and the second TRP; and determine a complementary cumulative distribution function for EIS based on the requirement for the minimum angular separation between the first TRP and the second TRP.

In certain embodiments, the complementary cumulative distribution function is a conditional complementary cumulative distribution function.

In some embodiments, the conditional complementary cumulative distribution function is used to set an EIS requirement, and the EIS requirement is less than a threshold value.

In various embodiments, the conditional complementary cumulative distribution function comprises a maximum interference requirement for the set of TRPs.

In one embodiment, the complementary cumulative distribution function is based on an exclusion zone.

In certain embodiments, the exclusion zone is determined by an exclusion angle.

In some embodiments, a size of the exclusion zone increases as the exclusion angle increases.

In various embodiments, the exclusion zone indicates a set of directions for which an angle between any direction in the set of directions and a direction of a first TRP is less than an exclusion angle and from which the second TRP is excluded.

In one embodiment, the EIS is expressed in dB.

In certain embodiments, the EIS is determined for a best beam of the first panel and for a best beam of the second panel.

In one embodiment, a method at a device, the method comprises: receiving communications from a set of TRPs concurrently at a first panel and a second panel, wherein the set of TRPs comprises a first TRP and a second TRP: identifying a requirement for a minimum angular separation between the first TRP and the second TRP; and determining a complementary cumulative distribution function for EIS based on the requirement for the minimum angular separation between the first TRP and the second TRP.

In certain embodiments, the complementary cumulative distribution function is a conditional complementary cumulative distribution function.

In some embodiments, the conditional complementary cumulative distribution function is used to set an EIS requirement, and the EIS requirement is less than a threshold value.

In various embodiments, the conditional complementary cumulative distribution function comprises a maximum interference requirement for the set of TRPs.

In one embodiment, the complementary cumulative distribution function is based on an exclusion zone.

In certain embodiments, the exclusion zone is determined by an exclusion angle.

In some embodiments, a size of the exclusion zone increases as the exclusion angle increases.

In various embodiments, the exclusion zone indicates a set of directions for which an angle between any direction in the set of directions and a direction of a first TRP is less than an exclusion angle and from which the second TRP is excluded.

In one embodiment, the EIS is expressed in dB.

In certain embodiments, the EIS is determined for a best beam of the first panel and for a best beam of the second panel.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive communications from a set of transmission and reception points (TRPs) concurrently at a first panel and a second panel, wherein the set of TRPs comprises a first TRP and a second TRP;
identify a requirement for a minimum angular separation between the first TRP and the second TRP; and
determine a complementary cumulative distribution function for effective isotropic sensitivity (EIS) based on the requirement for the minimum angular separation between the first TRP and the second TRP.

2. The UE of claim 1, wherein the complementary cumulative distribution function is a conditional complementary cumulative distribution function.

3. The UE of claim 2, wherein the conditional complementary cumulative distribution function is used to set an EIS requirement, and the EIS requirement is less than a threshold value.

4. The UE of claim 2, wherein the conditional complementary cumulative distribution function comprises a maximum interference requirement for the set of TRPs.

5. The UE of claim 1, wherein the complementary cumulative distribution function is based on an exclusion zone.

6. The UE of claim 5, wherein the exclusion zone is determined by an exclusion angle.

7. The UE of claim 6, wherein the exclusion angle is signaled by the UE.

8. The UE of claim 6, wherein a size of the exclusion zone increases as the exclusion angle increases.

9. The UE of claim 5, wherein the exclusion zone indicates a set of directions for which an angle between any direction in the set of directions and a direction of a first TRP is less than an exclusion angle and from which the second TRP is excluded.

10. The UE of claim 1, wherein the EIS is expressed in dB.

11. The UE of claim 1, wherein the EIS is determined for a best beam of the first panel and for a best beam of the second panel.

12. A method performed by a user equipment (UE), the method comprising:
receiving communications from a set of transmission and reception points (TRPs) concurrently at a first panel and a second panel, wherein the set of TRPs comprises a first TRP and a second TRP;
identifying a requirement for a minimum angular separation between the first TRP and the second TRP; and
determining a complementary cumulative distribution function for effective isotropic sensitivity (EIS) based on the requirement for the minimum angular separation between the first TRP and the second TRP.

13. The method of claim 12, wherein the complementary cumulative distribution function is a conditional complementary cumulative distribution function.

14. The method of claim 13, wherein the conditional complementary cumulative distribution function is used to set an EIS requirement, and the EIS requirement is less than a threshold value.

15. The method of claim 13, wherein the conditional complementary cumulative distribution function comprises a maximum interference requirement for the set of TRPs.

16. The method of claim 12, wherein the complementary cumulative distribution function is based on an exclusion zone.

17. The method of claim 16, wherein the exclusion zone is determined by an exclusion angle.

18. The method of claim 17, wherein the exclusion angle is signaled by the UE.

19. The method of claim 17, wherein a size of the exclusion zone increases as the exclusion angle increases.

20. A processor for wireless communication, comprising:
at least one controller coupled with at least one memory and configured to cause the processor to:
receive communications from a set of transmission and reception points (TRPs) concurrently at a first panel and a second panel, wherein the set of TRPs comprises a first TRP and a second TRP;
identify a requirement for a minimum angular separation between the first TRP and the second TRP; and
determine a complementary cumulative distribution function for effective isotropic sensitivity (EIS) based on the requirement for the minimum angular separation between the first TRP and the second TRP.
